(19) United States
(12) Patent Application Publication
(10) Pub. No.: US 2007/0154611 A1
(43) Pub. Date: Jul. 5, 2007

(54) Method to produce lupin protein-based dairy substitutes

(75) Inventors: John Snowden, Leeming (AU); Sofi Sipsas, Dianella (AU); Charmian St. John, Mount Lawley (AU)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: THE STATE OF WESTERN AUSTRALIA THROUGH ITS DEPARTM, South Perth (AU)

(21) Appl. No.: 10/554,664

(22) PCT Filed: Apr. 20, 2004
(86) PCT No.: PCT/AU04/00515

§ 371 Date: Nov. 21, 2006

(30) Foreign Application Priority Data
Apr. 24, 2003 (AU) 2003901942

(51) Int. Cl. A23C 9/154

(52) U.S. Cl. 426/580

(57) ABSTRACT

The present invention relates to a method for preparing a lupin-sourced protein-enriched preparation comprising the steps of: (a) solubilising the proteins from lupin meal using alkaline conditions, (b) precipitating the solubilised proteins, and (c) solubilising the precipitated proteins of step (b); from which lupin milk and derived products is made through (a) diluting the lupin-sourced protein-enriched preparation, and (b) blending fat, carbohydrate, and whitening ingredients to achieve desired organoleptic and nutritional qualities.

### FIELD OF THE INVENTION

This invention relates to an improved method for the purification and concentration of lupin proteins and particularly an improved method for the production of lupin protein-based dairy substitutes in the form of an aqueous dispersion of lupin proteins suitable for use in the production of derivative products that are substitutes for processed dairy milk products such as yoghurt, ice-cream and cheese.

### BACKGROUND ART

Lupins are leguminous plants that yield seed (grain), and are a valuable break crop within the cereal production rotation in Mediterranean climate environments. Lupin seed (grain) is rich in proteins of high nutritional value, but relatively low in fat. Previous attempts have been made to process lupin grain to produce milk-like, dairy replacement products, similar to those derived from soybeans (herein after termed “soybean milk” and “soybean milk products”).

Many of these attempts contain a pre-treatment process for removing undesirable anti-nutritive substances, particularly alkaloids and certain oligosaccharides (eg EP 084 547 describes using water as the extractant for debittering lupin grain). Plant breeders have improved the quality of commercial lupin grain, and decreased the levels of these undesirable anti-nutritive (bitter) substances in modern commercial (37 sweet”) lupin cultivars and so decreased the importance of the de-bittering for lupin processing.

EP 449 396 describes a process for preparing a lupin milk, which mirrors one of the methods used for processing soybeans for soybean milk production. Soaked lupin grain is ground, stirred in water to give a thick paste and the protein-containing lupin milk is pressed out. The resulting milk is intended as a raw material for the preparation of foodstuffs. However, the main disadvantages of this process is that the product separates upon standing into a translucent whey overlying a gritty yellow sludge containing the water-soluble, anti-nutritive substances described above. Human consumption of this product has been reported to result in unsatisfactory odour, visual, textural and taste responses, as well digestive system irregularities and flatulence (Kyle, 1994). The product is not suitable for use as a food in itself or as an ingredient for derivative products (Camacho, et al., 1988; Zhang et al., 2000) and as such has not been developed on a commercial scale.

Many existing methods for extracting proteins from legumes incorporate a defatting process using organic solvents to remove oil from the flaked grain. The use of such solvents is expensive, potentially environmentally dangerous and potentially detracts from the healthy image of plant protein-based milk products.

Other methods of protein extraction developed for soybeans (eg. U.S. Pat. No. 4,241,100) are not applicable to lupins.

There remains a commercial need to provide a simple, cost-effective and rapid procedure for producing protein preparations sourced from lupin grain that may be used as a substitute for products such as dairy milk and dairy-milk derived products, such as cheese, yoghurt and ice cream.

### SUMMARY OF THE INVENTION

The present invention relates to a method for preparing a lupin-sourced protein-enriched preparation suitable for use in lupin milk and derivative products, said method comprising the steps of: (a) solubilising the proteins from lupin meal using alkaline conditions, (b) precipitating the solubilised proteins, and (c) solubilising the precipitated proteins of step (b). Once the protein-enriched preparation has been solubilised in step (c) the pH of the preparation may then be adjusted to a pH of between about 6 and 7.5.

In a preferred form, the invention resides in a method for producing a lupin-sourced protein-enriched preparation suitable for use in lupin milk or lupin milk derivative products, said method comprising the steps of: (a) selecting a lupin material and milling that material to produce a lupin meal; (b) solubilising the proteins in the lupin meal using alkaline conditions; (c) separating the supematant from the precipitate; (d) precipitating solubilised proteins from the supematant produced in step (c); (e) separating the precipitate from the supernatant; (f) solubilising the precipitated proteins; (g) adjusting the pH of the solubilised protein preparation to a pH of between about 6 and 7.5 to produce a lupin-sourced protein-enriched preparation.

The present invention also relates to a lupin-sourced protein-enriched preparation produced according to the any one of the methods described herein.

In addition, the invention provides a method for producing lupin milk and/or lupin milk derivative products that are substitutes for dairy milk or soybean milk products, said method comprising the steps of:
(a) preparing a lupin-sourced protein-enriched preparation according to the method(s) described herein;
(b) diluting the lupin-sourced protein-enriched preparation to a concentration suitable for preparing a milk product; and
(c) adding to the dilute preparation products required to produce milk, which products may be selected from the group consisting of: fats; oil; carbohydrates; emulsifiers; salts; vitamins; and colouring agents.

Further, the invention relates to lupin milk produced using the lupin-sourced, protein-enriched preparation. Lupin milk and lupin milk products produced by the methods described herein have been found to be highly acceptable in terms of appearance, taste, texture and overall palatability compared to other lupin and soybean based products. As such they have clear commercial application as substitutes or alternatives for dairy milk and dairy milk products such as yoghurt, cheese and ice-cream and soybean milk and associated soybean milk products that substitute for yoghurt, cheese and ice-cream.

### DETAILED DESCRIPTION OF THE INVENTION

General

Those skilled in the art will appreciate that the invention described herein is susceptible to variations and modifications other than those specifically described. It is to be understood that the invention includes all such variation and modifications. The invention also includes all of the steps, features, compositions and compounds referred to or indicated in the specification, individually or collectively and any and all combinations or any two or more of the steps or features.

The present invention is not to be limited in scope by the specific embodiments described herein, which are intended for the purpose of exemplification only. Functionally equivalent products, compositions and methods are clearly within the scope of the invention as described herein.

The entire disclosures of all publications (including patents, patent applications, journal articles, laboratory manuals, books, or other documents) cited herein are hereby incorporated by reference. No admission is made that any of the references constitute prior art or are part of the common general knowledge of those working in the field to which this invention relates.

As used herein the term “derived” and “derived from” shall be taken to indicate that a specific integer may be obtained from a particular source albeit not necessarily directly from that source.

Throughout this specification, unless the context requires otherwise, the word “comprise”, or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

### DESCRIPTION OF THE PREFERRED EMBODIMENT

The inventors have found that by following the methods described herein they are able to produce a new lupin-sourced protein-enriched preparation that has wide ranging applications in the food industry. Preferably, the product is used in the preparation of lupin milk. Lupin milk can be used as a substitute for dairy milk or soybean milk and or it can be used to produce a range of products including, without limitation, yoghurt, cheese and ice-cream.

In one aspect the invention resides in a method for producing a lupin-sourced protein-enriched preparation suitable for use in lupin milk and derivative products, said method comprising the steps of:
(a) solubilising the proteins from lupin meal using alkaline conditions;
(b) precipitating the solubilized proteins; and
(c) solubilising the precipitated proteins of step (b).

Once the protein-enriched preparation has been solubilised by step (c) the pH of the preparation can then be adjusted to a pH of between about 6 and 7.5. The resultant product may then be used to prepare lupin milk and lupin milk products with particular use as substitutes for dairy milk and soybean milk products. According to a preferred embodiment, the invention provides a method for producing a lupin-sourced, protein-enriched preparation suitable for use in preparing lupin milk and derivative products, said method comprising the steps of:
(a) selecting a lupin material and milling that material to produce a lupin meal;
(b) solubilising proteins in the lupin meal using alkaline conditions;
(c) separating the supernatant from the precipitate;
(d) precipitating solubilised proteins from the supernatant produced in step (c);
(e) separating the precipitate from the supernatant;
(f) solubilising the precipitated proteins; and
(g) adjusting the pH of the solubilised protein preparation to a pH of between about 6 and 7.5 to produce a lupin-sourced, protein-enriched preparation. Preferably, in step (d), an acid solution is added to precipitate the solubilised proteins. The acid solution should adjust the pH of the preparation to between approximately pH 3 and pH 5.5.

Preferably, in step (f), an alkaline solution is added to solubilise the precipitated proteins. The alkaline solution should adjust the pH of the preparation to between approximately pH 8 and pH 10.

According to an even more preferred embodiment, the invention provides a method for producing a lupin-sourced, protein-enriched preparation suitable for use in preparing lupin milk and derivative products, said method comprising the steps of:
(a) selecting a lupin material and milling that material to produce a lupin meal;
(b) solubilising proteins in the lupin meal using alkaline conditions;
(c) separating the supematant from the precipitate;
(d) precipitating solubilised proteins from the supernatant produced in step (c) using an acid solution, which is capable of adjusting the pH to between about pH 3 and pH 5.5;
(e) separating the precipitate from the supernatant;
(f) solubilising the precipitated proteins using an alkaline solution, which is capable of adjusting the pH to between about pH 8 and pH 10; and
(g) adjusting the pH of the solution prepared in step (f) to a pH of between about 6 and 7.5 to produce a lupin-sourced protein-enriched preparation.

When producing lupin milk or lupin milk derived products, a lupin-sourced protein-enriched preparation is first prepared by any one of the above methods. The lupin-sourced protein-enriched preparation is then adjusted to a concentration of between 3 and 5% (w/v) after which fats, oils, carbohydrates, emulsifiers, salts, vitamins and colouring agents are added, as appropriate, to produce lupin milk and/or derivative products.

Various modifications may be made to the invention described without departing from the essence of the invention. The following description is provided to aid in understanding the invention but should not be read as a limitation of the method that forms the invention.

The first step in producing a lupin-sourced, protein-enriched preparation suitable for use in, for example, a lupin milk product is to prepare lupin meal from lupin material. Preferably, the lupin material used in the method is obtained from narrow leaf sweet lupins (Lupinus angustifolius), but other lupin species may be used including, for example, Lupinus albus, Lupinus luteus and Lupinus mutabilus. As used herein “lupin material” is not limited to lupin kernels, rather it includes any processed lupin material (e.g. partially processed lupin kernels) that can be ground to form lupin meal. Lupin kernels are, however, the most desired starting material for the method. When the lupin material is lupin kernels, the kernels should first be cleanly dehulled.

After selection of the lupin material, the material is then milled to produce a lupin meal. “Lupin meal” refers to ground lupin material. It may include particulate material of different sizes as well as flour. Preferably, lupin material is ground to produce a course meal having a particle size of between about 200 and 600 micrometers. More preferably, the lupin material is ground to produce a flour and particulate material composition.

Once the lupin meal has been prepared, the meal should be mixed gently with water or a like solution, to prepare a solution with a liquid to meal ratio in the range of between 5:1 and 20:1 (v/w), preferably 10:1 (v/w). Liquids suitable for mixing with the lupin meal include, for example, filtered water, sterilised water, purified water, deionized water and double deionized water.

The lupin meal Mixture is then adjusted to a pH of between pH 8 and 12 by the addition of an alkali solution. Preferably, the solution is adjusted to a pH of between about 8.5 and 9.5, such as a pH 9.0. When adding the alkaline solution, the lupin meal mixture should be stirred gently. During mixing, care should be taken to avoid foaming or frothing. Although any alkaline solution may be used to solubilise proteins within the lupin meal, a preferred alkaline solution is sodium hydroxide (NaOH). Alternatively, the hydroxides of any alkaline metal may be used such as ammonium hydroxide or potassium hydroxide.

The concentration of alkaline solution used to solubilise the lupin meal will depend on the alkaline solution used. Ideally, the concentration of the alkaline solution will be between about 0.1M and 10M. When the alkaline solution is NaOH the concentration of solution used will be about 1M.

During mixing, the solution of the lupin meal mixture and the alkaline solution should be kept at a temperature between about 0° C. and 40° C. Preferably, the solution is maintained at a temperature of between about 10° C. and 30° C. More preferably, the temperature of the solution is kept between about 20° C. to 25° C., like, for example, room temperature.

After mixing of the lupin meal mixture with the alkaline solution, the resultant slurry is maintained at the selected pH and selected temperature for at least 60 minutes. More preferably, the slurry is held at the selected pH and selected temperature for at least 90 minutes.

Next the supematant (which includes solubilised proteins) is separated from the precipitate (which contains a substantial portion of the carbohydrates) by conventional separation processes such as filtration or centrifugation. Preferably, the supernatant is separated from the precipitate by centrifugation.

Once the supernatant has been separated from the precipitate, the pH of the supernatant is adjusted to precipitate the lupin proteins from the supematant leaving soluble sugars and salts in solution. This may be achieved by adding an acid solution to the supernatant. Acid solutions suitable for the use in the invention are those that are capable of: (a) precipitating the solubilised proteins without degrading them; and (b) that result in a product safe for consumption by a mammal. For example, the acid solution might be hydrochloric acid or acetic acid, but any mineral or organic acid that meets the previously mentioned conditions may be used. To precipitate the proteins the pH of the solubilised protein fraction is adjusted to a pH between pH 3.0 and 5.5 and more preferably to a pH between about pH 3.5 to 5. In an example of the invention the pH is adjusted to 4.5. During mixing, the solution should be kept at a temperature between about 0° C. and 40° C. Preferably, the solution is maintained at a temperature of between about 10° C. and 30° C. More preferably, the temperature of the solution is kept between about 20° C. to 25° C. For example, the solution is kept at room temperature.

Since lupin proteins are insoluble in an acidic pH, they can be separated from soluble sugars, salts, etc., by centrifugation or other conventional means.

Once the lupin proteins have precipitated from solution, the precipitated proteins are then suspended in water or a water-like liquid to prepare a solution with a liquid/precipitate ratio of about 10:1w/v. Liquids suitable for mixing with the lupin proteins include, for example, filtered water, sterilised water, purified water, deionized water and double deionized water.

After the precipitated proteins have been mixed in water or a water-like liquid, the pH of the solution is raised to a pH of between about 8 and 10. Preferably, the solution is raised to a pH of between about 8.5 and 9.5, like for example a pH of 9.0. When adding the alkaline solution, the solution should be stirred gently. Although any alkaline solution may be used to solubilise proteins within the lupin meal, preferred aqueous alkaline solution that is used is sodium hydroxide (NaOH). Alternatively, the hydroxides of any alkaline metal may be used such as ammonium hydroxide or potassium hydroxide.

During mixing, the solution should be kept at a temperature between about 0° C. and 40° C. Preferably, the solution is maintained at a temperature of between about 10° C. and 30° C. More preferably, the temperature of the solution is kept between about 20° C. to 25° C. For example, the solution is kept at room temperature.

Once suitable alkaline conditions are reached the solution can be centrifuged or filtered again to remove any remaining undissolved material. The pH of the solution is then adjusted as required to between pH 6 and 7.

In a second aspect, the invention resides in a lupin-sourced protein-enriched preparation produced according to the above method.

The lupin-sourced protein-enriched preparation produced according to the described method has a number of applications in the food industry. For example, the lupin-sourced protein-enriched preparation may be used:
(a) to produce lupin milk or lupin milk products;
(b) as an emulsifier or emulsion stabilizer;
(c) as a binder, that is capable of binding fat or water, similar to other protein isolates;
(d) in applications requiring a low-flavour profile, water and fat absorption and emulsification (dispersible form);
(e) to protect food products in conditions that stress the product, such as freeze-thaw cycles; or
(f) to extended holding times of precooked or cooked products.

In a third aspect the invention provides a method for preparing lupin milk products using the lupin-sourced protein-enriched preparation. Lupin milk and lupin milk products produced using the protein-enriched preparation described above have substantially improved sensory appeal (esp. white opaque colour, smooth texture, neutral smell, pleasant palate) and end use versatility over products emanating from previous attempts to produce dairy substitutes from lupin grain.

Accordingly the invention provides a method for preparing lupin milk product that may serve as a substitute for dairy milk or soybean milk, said method comprising the steps of:
(a) adjusting the concentration of the lupin-sourced protein-enriched preparation produced according to any of the methods described above to between 3 and 5% (w/v), by the addition of a liquid such as water or a water-like solution; and
(b) mixing with the solution prepared in step (a) bland vegetable fat and/or oil in an amount suitable for preparing a milk product.

The amount of fat or oil used in step (b) may be varied depending on the type of product required. For example, up to around 3.5% (w/v) fat or oil is used for “full cream” milk.

Carbohydrates including malodextrin and sugars such as glucose and/or sucrose can also be added to the mixture. For example, the amount of carbohydrates that might be added to the solution will be about 3%(w/v).

Lactose can also be added if a lactose free product is not required. The addition of lactose can also be used to facilitate yoghurt production.

Other additives may also be added including vegetable-based emulsifiers e.g. lethicin, and mineral salts such sodium chloride and phosphates of calcium, magnesium and potassium. Food grade colouring agents can also be used to improve the appearance of the product. Vitamins may also be added.

A convenient and simple method of providing the additional ingredients such as fats/oils, carbohydrates and other additives is to add a coffee whitener, non-dairy creamer or like product to the diluted lupin-sourced, protein-enriched preparation to make lupin milk. For example, Coffee-mate® may be used for simplicity to provide vegetable fat, a vegetable emulsifier, carbohydrate, minerals and food colour in the one product.

Lupin milk produced by the above method will preferably be homogenised and pasteurised before packaging.

When the lupin-sourced protein-enriched preparation is not used in the preparation of a dairy or soybean milk substitute, the preparation may prepared in gel form or as an emulsion with another liquid. When prepared in this manner the invention may find utility as an ingredient in foodstuffs, drinks (e.g., energy or sports drinks) and animal feeds. For example, the emulsion and/or gel may possibly be used as an ingredient in, baby food, bakery products (for example, a bread, yeasted good or cake) or bakery supply products (for example, custard or bakery fillings or toppings), batter or breading, cereal, confectionary, flavour or beverage emulsions, fruit fillings, gravy, soups, sauces (eg meat sauces) or food thickeners, UHT treated gravy, meal components (e.g., vegetarian meal/components), meat products (e.g., comminuted meat products, sausages, burgers, grill steaks, canned meats, meat pies, fish preparations, meat patties, meat spread and pastes), pizza toppings, pet foods, pharmaceuticals or neutraceuticals, potato products, dressings (e.g., salad or low fat dressings), snack or cracker spreads (e.g., savoury or sweet spreads), pasta products (e.g. noodles), fat-filled powders, quiches or flans, cheese or cream mimetics and other substitute dairy products not specifically detailed within this description of invention (e.g. desserts, flavoured milk drinks, milk shakes, cheeses, cheese spreads or dips).

### Descriptions to Carry Out the Invention

The following description serves to more fully explain the manner of preparing the above-described invention, as well as to set forth the best mode contemplated for carrying out various aspects of the invention. It should be understood that this descriptions in no way serves to limit the true scope of this invention, but rather is presented for illustrative purposes only.

Preparation of “Full Cream” Lupin Milk

Lupin meal was prepared by grinding L. angustifolius var Myallie grain. To 100 g of meal, 1L of filtered water was added with gently stirring. The pH of the mixture was adjusted to pH 9 by the addition of 1M NaOH. The mixture was stirred for at least 90 minutes at room temperature (approximately 25° C.).

The mixture was then filtered through a fine cloth filter and the filtrate collected. The pH of the filtrate was adjusted to pH 4.5 by the addition of 1M HCI. The solution was then centrifuged at 8,000 G for 15 minutes and the supernatant removed.

The precipitated protein pellet was resuspended in 1L of water and the pH adjusted to pH 9 by the addition of 1M NaOH. After stirring for at least 30 minutes at room temperature (approximately 25° C.), the pH was adjusted to pH 6.5 by the addition of 1M HCI.

The lupin protein solution described above was heated to approximately 60° C. with stirring. Approximately 110 g of Coffee-mate® was added and the mixture stirred as the temperature was raised to 85° C. The solution was filtered through sterile cotton wool and cooled to 5° C.

Coffee-mate® was used for simplicity to provide vegetable fat, a vegetable emulsifier, carbohydrate, minerals and food colour in the one product.

Preparation of “Light” Lupin Milk

A lupin milk dairy substitute was prepared in a similar manner to that above however only 70 g of Coffee-mate® was added in order to produce a ‘light’ version of the dairy substitute.

Preparation of Lupin “Yoghurt”

250 mL of lupin milk and 17 g of skim milk powder or 17 g of Coffeemate® were mixed thoroughly and then heated to around 90° C. The mixture allowed to cool to around 45° C. and then 25 g of commercial yogurt was added as a starter culture. The yogurt was then set overnight at 40° C. The yogurt was then refrigerated until required.

Preparation of Lupin “Ice Cream”

200 mL of lupin milk, prepared as described above, 60 g of vegetable fat (oil) 150 g of sucrose, 1 OmL of 1% (w/v) carrageenan type 1 and 170 mL of water were mixed thoroughly. Strawberry topping and lemon juice were added to taste. The mixture was then beaten for 2 minutes and then placed in a freezer. The mixture was then beaten for two minutes every 30 minutes for 2 hours. Then kept frozen until required.

Product Testing of the Invention

The lupin protein based milk prepared by the procedure described above and yoghurt prepared by the procedure described thereafter, was fed to 30 food tasters.

All tasters found the lupin protein based milk to be acceptable in terms of appearance, taste, texture and overall palatability. Twenty-nine tasters stated that the lupin product was superior to the two commercial soybean based milk products included in the tasting protocol.

All thirty tasters considered the yoghurt prepared from the lupin milk was superior to the commercial soybean based yoghurt product.

### REFERENCES

Kyle, W. S. A., (1994). The current and potential uses of lupins for human food. In: M. Dracup and J. Palta (Eds). Proceedings of the First Australian Lupin Technical Symposium. Westem Australian Department of Agriculture, South Perth. pp. 110-114.

Camacho, L., Vasques, M., Leiva, M. Vargas, E., (1988). Effect of processing and methionine addition on the sensory quality and nutritive value of spray-dried lupin milk. International Joumal of Food Science and Technology 23, pp. 233-240

Zhang, H., Petterson, D., Fairbrother, A., (2000). The study of using Australian sweet lupin Lupinus angustifolius to make yoghurt. Institute of Food Technologists. 2000 IFT Annual Meeting, June 10-14, Dallas, Tex.

We claim:

1. A method for preparing a lupin-sourced protein-enriched preparation, said method comprising the steps of:
(a) solubilising proteins from lupin meal under alkaline conditions;
(b) precipitating the solubilised proteins; and
(c) solubilising the precipitated proteins of step (b).

2. The method according to claim 1 wherein the pH of the alkaline conditions used in step (a) is between about 8 and 12.

3. The method according to claim 1 wherein the pH of the solution in step (c) is adjusted to between about 6 and 7.5 after the protein precipitate has been solubilised in step (c).

4. A method for producing a lupin-sourced, protein-enriched preparation suitable for use in preparing lupin milk and derivative products, said method comprising the steps of:
(a) selecting a lupin material and milling that material to produce a lupin meal;
(b) solubilising proteins in the lupin meal using alkaline conditions;
(c) separating the supernatant from the precipitate;
(d) precipitating solubilised proteins from the supernatant produced in step (c);
(e) separating the precipitate from the supernatant;
(f) solubilising the precipitated proteins; and
(g) adjusting the pH of the solubilised protein preparation produced in step (f) to a pH of between about 6 and 7.5 to produce a lupin-sourced, protein-enriched preparation.

5. A method according to claim 4 wherein the proteins in the supernatant produced in step (c) are precipitated in step (d) using an acid solution that is capable of adjusting the pH of the solution to between about pH 3.0 and pH 5.5.

6. A method according to claim 4 wherein the protein precipitate produced in step
(e) is solubilised in step (f) using an alkaline solution that is capable of adjusting the pH of the solution to between about pH 8.0 and 10.

7. A method for producing a lupin-sourced, protein-enriched preparation suitable for use in preparing lupin milk and derivative products, said method comprising the steps of:
(a) selecting a lupin material and milling that material to produce a lupin meal;
(b) solubilising proteins in the lupin meal using alkaline conditions;
(c) separating the supernatant from the precipitate;
(d) precipitating solubilised proteins from the supematant produced in step (c) using an acid solution which is capable of adjusting the pH of the solution to between about pH 3.0 and pH 5.5;
(e) separating the precipitate from the supernatant;
(f) solubilising the precipitated proteins using an alkaline solution that is capable of adjusting the pH of the solution to between about pH 8.0 and 10; and
(g) adjusting the pH of the solubilised protein preparation produced in step (f) to a pH of between about 6 and 7.5 to produce a lupin-sourced, protein-enriched preparation.

8. A method for preparing lupin milk or lupin milk derivative products, said method comprising the steps of:
(a) preparing a lupin-sourced protein-enriched preparation according to the method of any one of claims 1 to 7;
(b) diluting the preparation to a concentration suitable for preparing a milk product; and
(c) adding to the dilute preparation, products suitable for the production of milk, which products may be selected from the group consisting of: fats; oil;
carbohydrates; emulsifiers; salts; vitamins; and colouring agents.

9. A method of producing lupin milk comprising the steps of:
(a) preparing a lupin-sourced protein-enriched preparation according to the method of any one of claims 1 to 7;
(b) Diluting the lupin-sourced protein-enriched preparation to produce a solution wherein the lupin-sourced protein is at a concentration between about 3 and 5% (w/v);
(c) mixing with the solution prepared in step (b), bland vegetable fat and/or oil in an amount suitable for preparing a milk product.

10. The method of claim 9 wherein the fat and/or oil is added to produce a concentration of between 2.5 and 5% (w/v).

11. The method of claim 10 wherein the fat and/or oil is added to produce a concentration of about 3.5% (w/v).

12. The method of claim 9 wherein in step (c) of the method, carbohydrates suitable for the preparation of milk are added to the solution at a concentration of between 1 and 5% (w/v).

13. The method of claim 12 wherein in step (c) of the method, carbohydrates suitable for the preparation of milk are added to the solution at a concentration of about 3% (w/v).

14. The method of claim 12 wherein one of the added carbohydrates is lactose.

15. A lupin-sourced protein-enriched preparation prepared by the method of any one of claims 1 to 7.

16. A method of producing lupin milk comprising the step of: adding to the lupin-sourced protein-enriched preparation of claim 15 a coffee whitener, non-dairy creamer or like product to produce lupin milk.

17. The method of claim 13 wherein the coffee whitener, non-dairy creamer or like product is Coffee-mate®.

18. A method according to any one of claims 1 to 6 wherein the lupin meal is obtained from a lupin species selected from the group consisting of: Lupinus angustifolius, Lupinus albus, L. luteus and L. mutabilus.

19. A method according to any one of claims 1 to 14 or 16 to 18 wherein the lupin meal is obtained from the narrow leaf sweet lupin species Lupinus angustifolius.
